(19) United States
(12) Patent Application Publication
(10) Pub. No.: US 2020/0127321 A1
(43) Pub. Date: Apr. 23, 2020

(54) LITHIUM SECONDARY BATTERY INCLUDING ISOCYANATE COMPOUND

(71) Applicant: SAMSUNG SDI CO., LTD., Yongin-si (KR)

(72) Inventors: Soojin KIM, Yongin-si (KR); Pavel SHATUNOV, Yongin-si (KR); Huijung PARK, Yongin-si (KR); Junyong LEE, Yongin-si (KR); Taesik KIM, Yongin-si (KR)

(21) Appl. No.: 16/587,282

(22) Filed: Sep. 30, 2019

(30) Foreign Application Priority Data
Oct. 23, 2018 (KR) 10-2018-0126859

(51) Int. Cl. H01M 10/056; H01M 10/0525; H01M 4/38

(52) U.S. Cl. CPC H01M 10/056; H01M 10/0525; H01M 2300/0068; H01M 2300/0025; H01M 4/382

(57) ABSTRACT

A lithium secondary battery including a cathode; an anode; and an electrolyte between the cathode and the anode, wherein the electrolyte includes a lithium salt; a non-aqueous solvent; and an isocyanate compound, and the cathode includes a cathode active material represented by Formula 1, below,

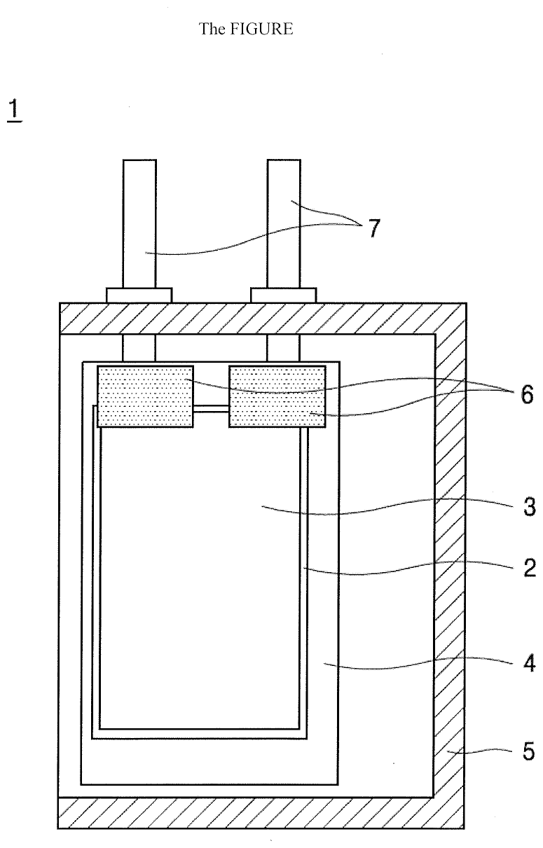

LiₓNi_{y}M_{1-y}O_{2-z}A_{z} <Formula 1>
wherein, in Formula 1, x, y, and z satisfy the following relations: 0.9≤x≤1.2, 0.6<y≤0.98, and 0≤z<0.2, M is Al, Mg, Mn, Co, Fe, Cr, V, Ti, Cu, B, Ca, Zn, Zr, Nb, Mo, Sr, Sb, W, or Bi, and A is an element having an oxidation number of −1 or −2.

### CROSS-REFERENCE TO RELATED APPLICATION

Korean Patent Application No. 10-2018-0126859, filed on Oct. 23, 2018, in the Korean Intellectual Property Office, and entitled: “Lithium Secondary Battery Including Isocyanate-Based Compound,” is incorporated by reference herein in its entirety.

### BACKGROUND

### 1. Field

Embodiments relate to a lithium secondary battery including an isocyanate compound.

### 2. Description of the Related Art

Lithium secondary batteries may be used as power sources for driving portable electronic appliances such as video cameras, mobile phones, and notebook computers. Rechargeable lithium secondary batteries may have three times higher energy density per unit weight than, e.g., lead batteries, nickel-cadmium batteries, nickel metal hydride batteries, and nickel-zinc batteries, and may be charged at high speed.

As cathode active materials included in cathodes of lithium secondary batteries, lithium-containing metal oxides may be used. For example, a composite oxide of lithium and cobalt (Co), manganese (Mn), nickel (Ni), or a combination thereof may be used. Among these, in the case of high-Ni-content cathode active materials, studies have recently been conducted on such materials because they may realize a higher capacity battery as compared with lithium cobalt oxide.

### SUMMARY

The embodiments may be realized by providing a lithium secondary battery including a cathode; an anode; and an electrolyte between the cathode and the anode, wherein the electrolyte includes a lithium salt; a non-aqueous solvent; and an isocyanate compound, and the cathode includes a cathode active material represented by Formula 1, below,

LiₓNi_{y}M_{1-y}O_{2-z}A_{z} <Formula 1>

wherein, in Formula 1, x, y, and z satisfy the following relations: 0.9≤x≤1.2, 0.6<y≤0.98, and 0≤z<0.2, M is Al, Mg, Mn, Co, Fe, Cr, V, Ti, Cu, B, Ca, Zn, Zr, Nb, Mo, Sr, Sb, W, or Bi, and A is an element having an oxidation number of −1 or −2.

The isocyanate compound may include at least one isocyanate group.

The isocyanate compound may be represented by Formula 2 below:

X₁—N═C═O <Formula 2>

wherein, in Formula 2, X₁ may be —Si(R)₃, —S(═O)₂R, —Si(R)₂—O—Si(R)₃, —C(═O)OR, or —P(R)₂, each R may be independently hydrogen, —F, —Cl, —Br, —I, an isocyanate group, a cyano group, a nitro group, an amidino group, a hydrazino group, hydrazono group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂), at least one substituent of the substituted C₁-C₂₀ alkyl group, the substituted C₂-C₂₀ alkenyl group, the substituted C₂-C₂₀ alkynyl group, and the substituted C₁-C₂₀ alkoxy group may be deuterium, —F, —Cl, —Br, —I, a hydroxyl group, a cyano group, a nitro group, an amidino group, a hydrazino group, a hydrazono group, a C₁-C₁₀ alkyl group, a C₂-C₁₀ alkenyl group, a C₂-C₁₀ alkynyl group, or a C₁-C₂₀ alkoxy group, and Q₁ to Q₃ may be each independently hydrogen, deuterium, —F, —Cl, —Br, —I, a hydroxyl group, a cyano group, a nitro group, an amidino group, a hydrazino group, hydrazono group, a C₁-C₂₀ alkyl group, a C₂-C₂₀ alkenyl group, a C₂-C₂₀ alkynyl group, or a C₁-C₂₀ alkoxy group.

The isocyanate compound may include one isocyanate group, and X₁ may be —S(═O)₂R, —Si(R)₂—O—Si(R)₃ or —C(═O)OR, or R may be —F, or the isocyanate compound may include two or three isocyanate groups, and X₁ may be —Si(R)₃, —S(═O)₂R, —Si(R)₂—O—Si(R)₃, or —C(═O)OR.

The isocyanate compound may be a compound represented by one of Formulae 2-1 to 2-5:

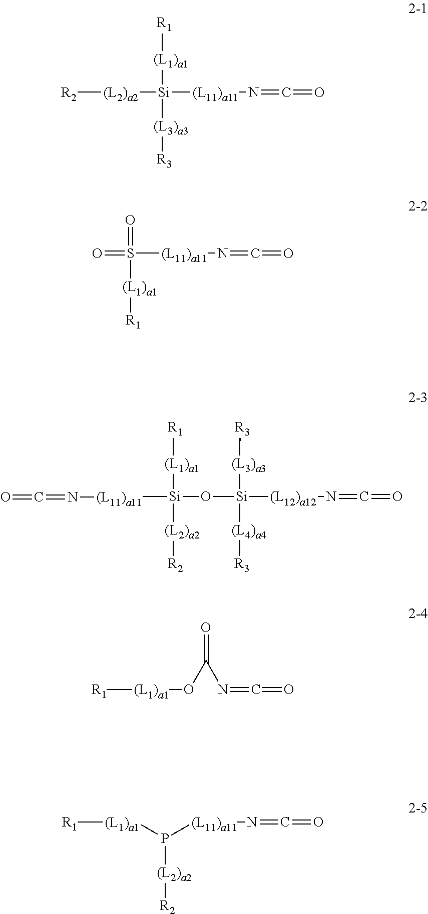

wherein, in Formulae 2-1 to 2-5, L₁ to L₄ and L₁₁ may be each independently a single bond, *—O—*′, or a substituted or unsubstituted C₁-C₃₀alkylene group, a1 to a4 and a11 may be each independently an integer of 1 to 5, R₁ to R₄ may be each independently —F, —Cl, —Br, —I, an isocyanate group, a cyano group, a nitro group, an amidino group, a hydrazino group, a hydrazono group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂), at least one substituent of the substituted C₁-C₃₀ alkylene group, the substituted C₁-C₂₀ alkyl group, the substituted C₂-C₂₀ alkenyl group, the substituted C₂-C₂₀ alkynyl group, and the substituted C₁-C₂₀ alkoxy group may be deuterium, —F, —Cl, —Br, —I, a hydroxyl group, a cyano group, a nitro group, an amidino group, a hydrazino group, a hydrazono group, a C₁-C₁₀ alkyl group, a C₂-C₁₀ alkenyl group, a C₂-C₁₀ alkynyl group, or a C₁-C₂₀ alkoxy group, Q₁ to Q₃ may be each independently hydrogen, deuterium, —F, —Cl, —Br, —I, a hydroxyl group, a cyano group, a nitro group, an amidino group, a hydrazino group, hydrazono group, a C₁-C₂₀ alkyl group, a C₂-C₂₀ alkenyl group, a C₂-C₂₀ alkynyl group, or a C₁-C₂₀ alkoxy group, and each of * and *′ indicates a binding site to an adjacent atom.

R₁ to R₄ may be each independently a methyl group, an ethyl group, a propyl group, an iso-propyl group, a butyl group, an iso-butyl group, a sec-butyl group, a tert-butyl group, —F, —Cl, —Br, —I, a methoxy group, an ethoxy group, an ethenyl group, an isocyanate group, or a —CF₃ group.

The isocyanate compound may include one isocyanate group or two isocyanate groups.

The isocyanate compound may be one of compounds 1 to 10 below:

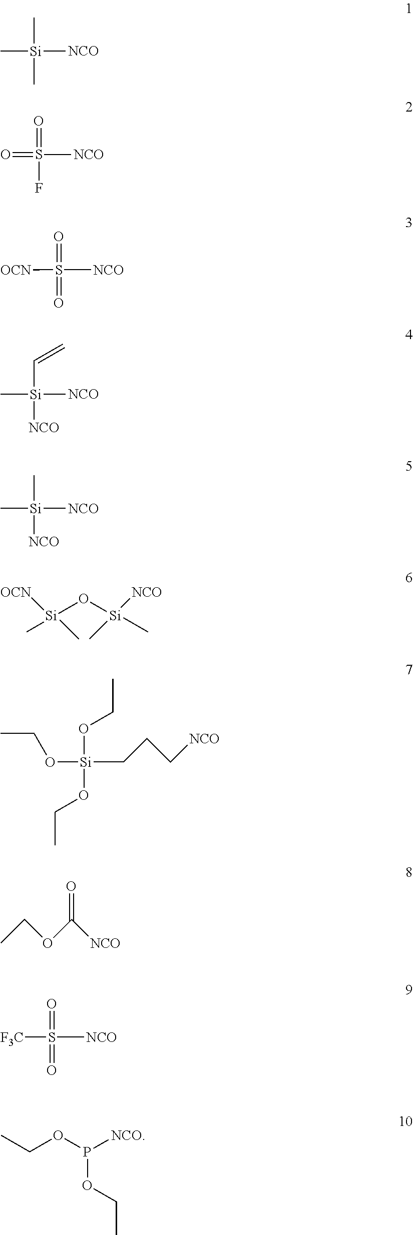

The isocyanate compound may be included in the electrolyte in an amount of about 0.005 wt % to about 10 wt %, based on a total weight of the electrolyte.

The isocyanate compound may be included in the electrolyte in an amount of about 0.01 wt % to about 5 wt %, based on a total weight of the electrolyte.

The non-aqueous solvent may include ethylmethyl carbonate, methylpropyl carbonate, ethylpropyl carbonate, dimethyl carbonate, diethyl carbonate, dipropyl carbonate, propylene carbonate, ethylenecarbonate, fluoroethylene carbonate, butylene carbonate, ethyl propionate, propyl propionate, ethyl butyrate, acetonitrile, dimethyl sulfoxide, dimethyl formamide, dimethylacetamide, gamma-valerolactone, gamma-butyrolactone, or tetrahydrofuran.

The lithium salt may include LiPF₆, LiBF₄, LiSbF₆, LiAsF₆, LiClO₄, LiBr, CH₃SO₃Li, (CF₃SO₂)₂NLi, lithium chloroborane, lower aliphatic carboxylic acid lithium, lithium 4-phenylborate, lithium imide, LiCF₃SO₃, LiCF₃CO₂, LiBioCl₁₀, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂), in which each of x and y is independently an integer of 1 to 20, LiCl, or LiI.

A concentration of the lithium salt in the electrolyte may be about 0.01 M to about 5.0 M.

The cathode active material may be represented by Formula 3 or Formula 4 below:

LiₓNi_{y}Co_{1-y′-y″}—Al_{y″}O₂ <Formula 3>

Li_{x′}Ni_{y′}Co_{1-y′-y″}Mn_{y″}O₂ <Formula 4>

wherein, in Formulae 3 and 4, x′, y′, and y″ may satisfy the following relations: 0.9≤x′≤1.2, 0.6<y′≤0.98, 0<y″<0.1, and 0<1−y′−y″<0.2.

The anode may include lithium metal, a metal alloyable with lithium, a transition metal oxide, a non-transition metal oxide, or a carbon material.

The lithium secondary battery may further include a urethane group-containing film on a surface of the cathode or the anode.

The urethane group-containing film may be on the surface of the anode.

The cathode or the anode may include a —OH group or H₂O on a surface thereof, and a urethane group of the urethane group-containing film may be formed by a reaction of the —OH group or the H₂O with an isocyanate group of the isocyanate compound.

A DCIR increase rate after 200 charge-discharge cycles at 45° C. may be 100% or less.

### BRIEF DESCRIPTION OF THE DRAWING

Features will be apparent to those of skill in the art by describing in detail exemplary embodiments with reference to the attached drawing in which:

The FIGURE illustrates a schematic view of a lithium secondary battery according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout. As used herein, the term “or” is not an exclusive term, and includes any individual or combination of listed elements, e.g., “A or B” would include A, B, or A and B.

Hereinafter, lithium secondary batteries according to embodiments will be described in detail.

As used herein, the term “hydrocarbon” refers to an organic compound including carbon and hydrogen. For example, hydrocarbon may include a single bond, a double bond, a triple bond, or a combination thereof.

As used herein, “a” and “b” in “Ca-Cb” refer to the number of carbon atoms in a specific functional group. For example, the functional group may include “a” to “b” carbon atoms. Therefore, for example, the “C₁-C₄ alkyl groups” refers to alkyl groups having 1 to 4 carbon atoms, such as CH₃—, CH₃CH₂—, CH₃Ch₂CH₂—, (CH₃)₂CH—, CH₃CH₂CH₂CH₂—, CH₃CH₂CH(CH₃)—, and (CH₃)₃C—.

Certain radical nomenclature may include mono-radicals or di-radicals depending on the context. For example, when one substituent requires two connection points in the remaining molecule, it is to be understood that the substituent is a di-radical. For example, the substituents recognized as alkyl groups requiring two connecting points include di-radicals such as —CH₂—, —CH₂CH₂—, and —CH₂CH(CH₃)CH₂—. Another radical nomenclature clearly indicates that the radical is a di-radical such as “alkylene” or “alkenylene”.

As used herein, the term “alkyl group” or “alkylene group” refers to a branched or unbranched aliphatic hydrocarbon group. In an embodiment, the alkyl group may be substituted or unsubstituted. Examples of the alkyl group may include a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, and a cycloheptyl group. In another embodiment, these alkyl groups may be selectively substituted. In another embodiment, the alkyl group may include 1 to 6 carbon atoms. Examples of the alkyl group having 1 to 6 carbon atoms may include a methyl group, an ethyl group, a propyl group, an iso-propyl group, a butyl group, an iso-butyl group, a sec-butyl group, a pentyl group, a 3-pentyl group, and a hexyl group.

As used herein, the term “alkenyl group” is a hydrocarbon group having 2 to 20 carbon atoms including at least one carbon-carbon double bond, and examples thereof may include an ethenyl group, a 1-propenyl group, a 2-propenyl group, a 2-methyl-1-propenyl group, a 1-butenyl group, a 2-butenyl group, a cyclopropenyl group, a cyclopentenyl group, a cyclohexenyl group, and a cyclopentenyl group. In another embodiment, the alkenyl group may be substituted or unsubstituted. In another embodiment, the number of carbon atoms in the alkenyl group may be 2 to 40.

As used herein, the term “alkynyl group” is a hydrocarbon group having 2 to 20 carbon atoms including at least one carbon-carbon triple bond, and examples thereof may include an ethynyl group, a 1-propynyl group, a 2-propynyl group, a 1-butynyl group, and a 2-butynyl group. In another embodiment, the alkynyl group may be substituted or unsubstituted.

As used herein, the substituent is derived from an unsubstituted parent group. Here, at least one hydrogen atom is substituted with another atom or functional group. Unless otherwise expressed, when the function group is considered “substituted”, it may mean that the functional group is substituted with at least one substituent selected from, e.g., a C₁-C₂₀ alkyl group, a C₂-C₂₀ alkenyl group, a C₂-C₂₀ alkynyl group, a C₁-C₂₀ alkoxy group, halogen, a cyano group, a hydroxy group, and a nitro group. When it is described that one functional group is “selectively substituted”, the functional group may be substituted with the aforementioned substituent.

A lithium secondary battery according to an aspect of an embodiment may include, e.g., a cathode; an anode; and an electrolyte between the cathode and the anode. In an implementation, the cathode may include a cathode active material represented by Formula 1 below. In an implementation, the electrolyte may include a lithium salt; a non-aqueous solvent; and an isocyanate compound (e.g., an isocyanate-based compound).

LiₓNi_{y}M_{1-y}O_{2-z}A_{z} <Formula 1>

In Formula 1,

x, y, and z, may satisfy the following relations: 0.9≤x≤1.2, 0.6<y≤0.98, and 0≤z<0.2.

M may be, e.g., Al, Mg, Mn, Co, Fe, Cr, V, Ti, Cu, B, Ca, Zn, Zr, Nb, Mo, Sr, Sb, W, or Bi. For example, M may be one or a combination of Al, Mg, Mn, Co, Fe, Cr, V, Ti, Cu, B, Ca, Zn, Zr, Nb, Mo, Sr, Sb, W, or Bi.

A may be, e.g., an element having an oxidation number of −1 or −2.

When the isocyanate compound is added to the electrolyte, there may be effects of decreasing the resistance before and after formation and decreasing the resistance increase rate due to high-temperature storage.

In an implementation, the isocyanate compound may include at least one isocyanate (—N═C═O) group.

Without being bound by theory, the reason why the isocyanate compound is added to the electrolytic solution to improve the performance of the lithium secondary battery will be described in more detail below.

Anions (e.g., PF₆⁻ anions) or anion side products (e.g., PF₅) of a lithium salt included in an electrolyte for a lithium secondary battery may be adsorbed on a cathode film or an anode film during charging and discharging of the lithium secondary battery, thereby causing deterioration of battery characteristics.

A film including a urethane group may be formed on the surface of an electrode by an isocyanate group included in the isocyanate compound prior to the anions (e.g., PF₆⁻ anions) or anion side products (e.g., PF₅) of the lithium salt, thereby improving the resistance characteristics of the lithium secondary battery.

In an implementation, the isocyanate compound may be, e.g., represented by Formula 2 below.

X₁—N═C═O <Formula 2>

In Formula 2, X₁ may be, e.g., —Si(R)₃, —S(═O)₂R, —Si(R)₂—O—Si(R)₃, —C(═O)OR, or —P(R)₂.

In an implementation, each R may independently be or include, e.g., hydrogen, —F, —Cl, —Br, —I, an isocyanate group, a cyano group, a nitro group, an amidino group, a hydrazino group, hydrazono group, a substituted or unsubstituted C₁-C₂₀ alkyl group (e.g., a —CF₃ group), a substituted or unsubstituted C₂-C₂₀ alkenyl group, a substituted or unsubstituted C₂-C₂₀ alkynyl group, a substituted or unsubstituted C₁-C₂₀ alkoxy group, Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),

In an implementation, at least one substituent of the substituted C₁-C₂₀ alkyl group, the substituted C₂-C₂₀ alkenyl group, the substituted C₂-C₂₀ alkynyl group, and the substituted C₁-C₂₀ alkoxy group may be, e.g., deuterium, —F, —Cl, —Br, —I, a hydroxyl group, a cyano group, a nitro group, an amidino group, a hydrazino group, a hydrazono group, a C₁-C₁₀ alkyl group, a C₂-C₁₀ alkenyl group, a C₂-C₁₀ alkynyl group, or a C₁-C₂₀ alkoxy group.

Q₁ to Q₃ may each independently be, e.g., hydrogen, deuterium, —F, —Cl, —Br, —I, a hydroxyl group, a cyano group, a nitro group, an amidino group, a hydrazino group, hydrazono group, a C₁-C₂₀ alkyl group, a C₂-C₂₀ alkenyl group, a C₂-C₂₀ alkynyl group, or a C₁-C₂₀ alkoxy group.

In an implementation, i) when the isocyanate compound includes one isocyanate group, X₁ may be —S(═O)₂R, —Si(R)₂—O—Si(R)₃, or —C(═O)OR, and R may be —F, and

In an implementation, ii) when the isocyanate compound includes two or three isocyanate groups, X₁ may be —Si(R)₃, —S(═O)₂R, —Si(R)₂—O—Si(R)₃, or —C(═O)OR.

In an implementation, the isocyanate compound may be a compound represented by one of Formulae 2-1 to 2-5.

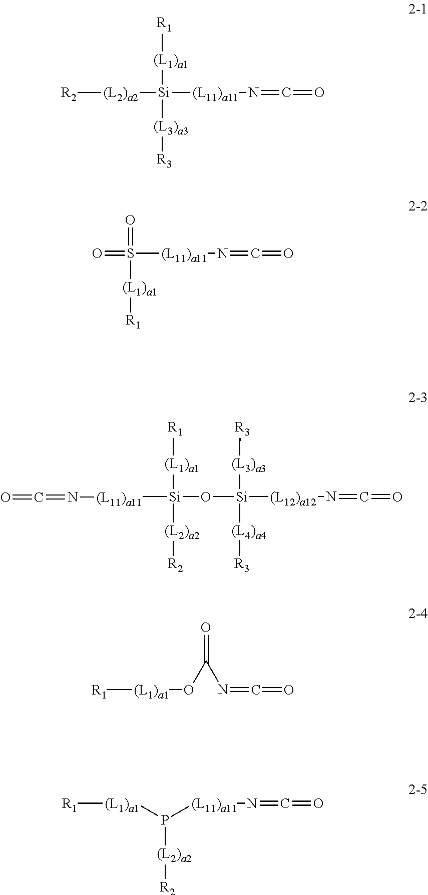

In Formulae 2-1 to 2-5,

L₁ to L₄ and L₁₁ may each independently be, e.g., a single bond, *—O—*′, or a substituted or unsubstituted C₁-C₃₀ alkylene group,

a1 to a4 and a11 may each independently be, e.g., an integer of 1 to 5,

R₁ to R₄ may each independently be, e.g., —F, —Cl, —Br, —I, an isocyanate group, a cyano group, a nitro group, an amidino group, a hydrazino group, hydrazono group, a substituted or unsubstituted C₁-C₂₀ alkyl group (e.g., a —CF₃ group), a substituted or unsubstituted C₂-C₂₀ alkenyl group, a substituted or unsubstituted C₂-C₂₀ alkynyl group, a substituted or unsubstituted C₁-C₂₀ alkoxy group, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),

In an implementation, at least one substituent of the substituted C₁-C₃₀ alkylene group, the substituted C₁-C₂₀ alkyl group, the substituted C₂-C₂₀ alkenyl group, the substituted C₂-C₂₀ alkynyl group, and the substituted C₁-C₂₀ alkoxy group may be, e.g., deuterium, —F, —Cl, —Br, —I, a hydroxyl group, a cyano group, a nitro group, an amidino group, a hydrazino group, a hydrazono group, a C₁-C₁₀ alkyl group, a C₂-C₁₀ alkenyl group, a C₂-C₁₀ alkynyl group, or a C₁-C₂₀ alkoxy group.

Q₁ to Q₃ may each independently be, e.g., hydrogen, deuterium, —F, —Cl, —Br, —I, a hydroxyl group, a cyano group, a nitro group, an amidino group, a hydrazino group, hydrazono group, a C₁-C₂₀ alkyl group, a C₂-C₂₀ alkenyl group, a C₂-C₂₀ alkynyl group, or a C₁-C₂₀ alkoxy group.

In an implementation, in Formulae 2-1 to 2-5, R₁ to R₄ may each independently be, e.g., a methyl group, an ethyl group, a propyl group, an iso-propyl group, a butyl group, an iso-butyl group, a sec-butyl group, a tert-butyl group, —F, —Cl, —Br, —I, a methoxy group, an ethoxy group, an ethenyl group, an isocyanate group, or a —CF₃ group.

In an implementation, the isocyanate-compound may include one (e.g., only one) isocyanate group or two (e.g., only two) isocyanate groups.

In an implementation, the isocyanate compound may be, e.g., one of the following Compounds 1 to 10.

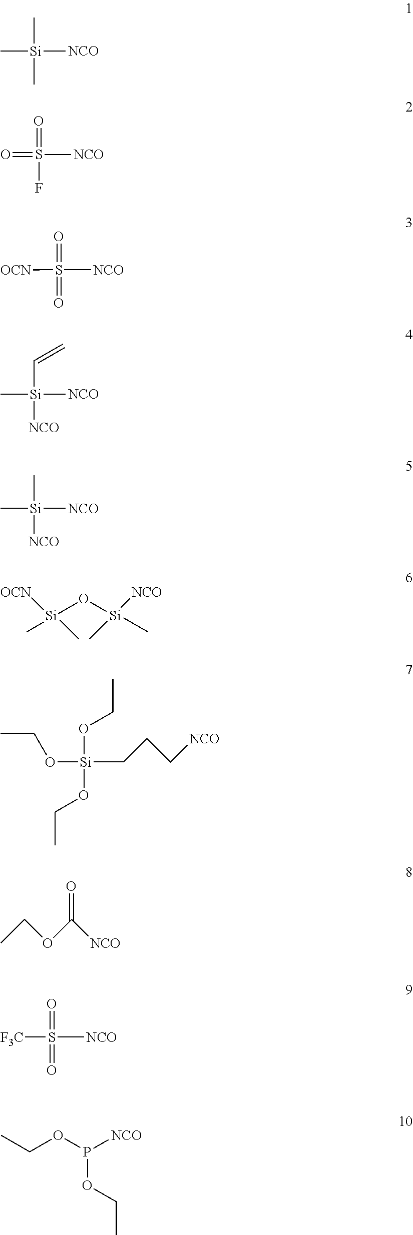

As used herein, —NCO is an isocyanate group (—N═C═O).

In an implementation, the isocyanate compound may be included in the electrolyte in an amount of about 0.005 wt % to about 10 wt %, e.g., about 0.01 wt % to about 5 wt %, based on a total weight of the electrolyte. In an implementation, a suitable amount of the isocyanate compound may be used as desired. In an implementation, the isocyanate compound may be included in the electrolyte in an amount of, e.g., about 0.01 wt % to about 4 wt %, based on the total weight of the electrolyte. In an implementation, the isocyanate compound may be included in the electrolyte in an amount of, e.g., about 0.01 wt % to about 3 wt %, based on the total weight of the electrolyte. In an implementation, the isocyanate compound may be included in the electrolyte in an amount of, e.g., about 0.01 wt % to about 2 wt %, based on the total weight of the electrolyte. In an implementation, the isocyanate compound may be included in the electrolyte in an amount of, e.g., about 0.05 wt % to about 2 wt %, based on the total weight of the electrolyte. In an implementation, the isocyanate compound may be included in the electrolyte in an amount of, e.g., about 0.05 wt % to about 1 wt %, based on the total weight of the electrolyte. Further improved battery characteristics may be obtained within the above amount ranges. If the amount of the isocyanate compound were more than 10 wt %, exceeding the above content range, based on the total weight of the electrolyte, battery life could be reduced. If the amount of the isocyanate compound were to be less than 0.005 wt %, it may be difficult to exhibit a desired effect of the present disclosure.

In an implementation, the non-aqueous solvent may include, e.g., ethylmethyl carbonate (EMC), methylpropyl carbonate, ethylpropyl carbonate, dimethyl carbonate (DMC), diethyl carbonate (DEC), dipropyl carbonate (DPC), propylene carbonate (PC), ethylenecarbonate (EC), fluoroethylene carbonate (FEC), butylene carbonate, ethyl propionate (EP), propyl propionate (PP), ethyl butyrate, acetonitrile, dimethyl sulfoxide, dimethyl formamide, dimethylacetamide, gamma-valerolactone, gamma-butyrolactone (GBL), or tetrahydrofuran. In an implementation, a suitable non-aqueous solvent may be used.

In an implementation, the concentration of the lithium salt in the electrolyte may be, e.g., about 0.01 M to about 5.0 M. A suitable concentration of the lithium salt may be used as needed. Further improved battery characteristics may be obtained within the above concentration range.

In an implementation, a suitable lithium salt may be used. In an implementation, the lithium salt may include LiPF₆, LiBF₄, LiSbF₆, LiAsF₆, LiClO₄, LiBr, CH₃SO₃Li, (CF₃SO₂)₂NLi, lithium chloroborane, lower aliphatic carboxylic acid lithium, lithium 4-phenylborate, lithium imide, LiCF₃SO₃, LiCF₃CO₂, LiBioCl₁₀, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (in which each of x and y is an integer of 1 to 20), LiCl, or LiI.

The electrolyte may be present in a liquid or gel state. The electrolyte may be prepared by adding the lithium salt and the isocyanate compound to the non-aqueous solvent.

The lithium secondary battery may have a suitable form. Examples of the lithium secondary battery may include a lithium ion battery, a lithium ion polymer battery, and a lithium sulfur battery.

In an implementation, the lithium secondary battery may be manufactured by the following method.

First, a cathode may be prepared.

For example, a cathode active material composition in which a cathode active material, a conductive material, a binder, and a solvent are mixed may be prepared. A cathode plate may be prepared by directly coating a metal current collector with the cathode active material composition. In an implementation, the cathode plate may be prepared by casting the cathode active material composition onto a separate support, separating a film from the support and then laminating the separated film on a metal current collector.

In an implementation, the cathode may include a cathode active material represented by Formula 1 above. In an implementation, in Formula 1 above, A may be, e.g., a halogen or sulfur.

In an implementation, in Formula 1 above, y indicates the content of Ni in the cathode active material, and 0.6<y≤0.98 may be satisfied. In an implementation, in Formula 1 above 0.7≤y≤0.98 may be satisfied. In an implementation, in Formula 1 above 0.8≤y≤0.9 may be satisfied. In an implementation, in Formula 1 above 0.8≤y≤0.88 may be satisfied. If the content of Ni in the cathode active material were to be 60% or less or the cathode active material containing no Ni were to be applied, an increase in surface resistance may not be great because surface reactivity at a voltage of 4.2 V or less is not high, the effect of surface reformation due to the material of Formula 1 could be slight, so that the effect of performance improvement may not be observed, and high capacity may not be exhibited.

In an implementation, the cathode active material may be, e.g., represented by Formula 3 or 4 below.

Li_{x′}Ni_{y′}Co_{1-y′-y″}Al_{y″}O₂ <Formula 3>

Li_{x′}Ni_{y′}Co_{1-y′-y″}Mn_{y″}O₂ <Formula 4>

In Formulae 3 and 4, x′, y′, and y″ may satisfy the following relations: 0.9≤x′≤1.2, 0.6<y′≤0.98, 0<y″<0.1, and 0<1−y′−y″<0.2.

In an implementation, a compound having a coating layer on the surface of the compound may be used, or a mixture of the compound and a compound having a coating layer may also be used. The coating layer may include a coating element compound such as oxide of a coating element, hydroxide of a coating element, oxyhydroxide of a coating element, oxycarbonate of a coating element, or hydroxycarbonate of a coating element. The compound constituting the coating layer may be amorphous or crystalline. As the coating element included in the coating layer, Mg, Al, Co, K, Na, Ca, Si, Ti, V, Sn, Ge, Ga, B, As, Zr, or a mixture thereof may be used. In the process of forming the coating layer, any coating method may be used (e.g., spray coating, dipping, or the like) if the method does not adversely influence the physical properties of the cathode active material by using such elements in the compound.

In an implementation, the conductive material may include, e.g., carbon black, graphite microparticles, or the like. In an implementation, a suitable conductive material may be used.

In an implementation, the binder may include, e.g., a vinylidene fluoride/hexafluoroproylene copolymer, polyvinylidene fluoride (PVDF), polyacrylonitrile, polymethyl methacrylate, polytetrafluoroethylene, a mixture thereof, or a styrene butadiene rubber polymer.

In an implementation, the solvent may include, e.g., N-methylpyrrolidone, acetone, or water.

The amount of the cathode active material, the amount of the conductive material, and the amount of the solvent may be suitable levels for a lithium battery. In an implementation, at least one of the conductive material, the binder, and the solvent may be omitted depending on the use and configuration of the lithium battery.

Next, an anode may be prepared.

For example, an anode active material composition in which an anode active material, a conductive material, a binder, and a solvent are mixed may be prepared. In an implementation, an anode plate may be prepared by directly coating a metal current collector with the anode active material composition and drying the anode active material composition. In an implementation, the anode plate may be prepared by casting the anode active material composition onto a separate support, separating a film from the support and then laminating the separated film on a metal current collector.

As the anode active material, a suitable anode active material for a lithium secondary battery may be used. In an implementation, the anode active material may include, e.g., a lithium metal, a metal alloyable with lithium, a transition metal oxide, a non-transition metal oxide, or a carbon material.

In an implementation, the metal alloyable with lithium may be, e.g., Si, Sn, Al, Ge, Pb, Bi, Sb, a Si—Y′ alloy (in which Y′ is selected from alkali metals, alkaline earth metals, Group 13 elements, Group 14 elements, transition metals, rare earth elements, and combinations thereof, not Si), or a Sn—Y″ alloy (in which Y″ is selected from alkali metals, alkaline earth metals, Group 13 elements, Group 14 elements, transition metals, rare earth elements, and combinations thereof, not Sn). In an implementation, Y′ and Y″ may be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, or Te.

In an implementation, the transition metal oxide may be, e.g., lithium titanium oxide, vanadium oxide, or lithium vanadium oxide.

In an implementation, the non-transition metal oxide may be SnO₂ or SiOₓ (in which 0<x<2).

In an implementation, the carbon material may be, e.g., crystalline carbon, amorphous carbon, or a mixture thereof. In an implementation, the crystalline carbon may be, e.g., graphite such as natural graphite or artificial graphite of an amorphous, plate-like, flake-like, spherical or fibrous form. In an implementation, the amorphous carbon may be, e.g., soft carbon (low-temperature sintered carbon), hard carbon, mesophase pitch carbide, or fired coke.

The conductive material, binder and solvent in the anode active material composition may be the same as those in the cathode active material composition.

The amount of the anode active material, the amount of the conductive material, and the amount of the solvent may be suitable levels for a lithium battery. In an implementation, at least one of the conductive material, the binder, and the solvent may be omitted, depending on the use and configuration of the lithium battery.

In an implementation, the lithium secondary battery may include a film including a urethane (—NH—C(═O)—) group (e.g., a urethane group-containing film) on the surface of the cathode or the anode. In an implementation, the lithium secondary battery may include the urethane group-containing film on the surface of the anode.

In an implementation, the cathode or the anode may include, e.g., a —OH group or H₂O on the surface thereof.

The urethane (—NH—C(═O)—) group of the urethane group-containing film may be formed by a reaction of the —OH group or the H₂O (from the surface of the cathode or anode) with an isocyanate group (e.g., from the isocyanate compound of the electrolyte).

Next, a separator to be inserted between the cathode and the anode may be prepared.

The separator may include a suitable separator for a lithium battery. A separator having low resistance to the movement of ions in the electrolyte and superior in electrolyte wettability may be used. In an implementation, the separator may include, e.g., glass fiber, polyester, Teflon, polyethylene, polypropylene, polytetrafluoroethylene (PTFE), or combinations thereof, and may be made in the form of nonwoven fabric or woven fabric. For example, a windable separator including polyethylene, polypropylene, or the like may be used in a lithium ion battery, and a separator having good electrolyte impregnation ability may be used in a lithium ion polymer battery. For example, the separator may be produced by the following method.

A polymer resin, a filler, and a solvent may be mixed to prepare a separator composition. The separator composition may be directly applied on an electrode and dried to form a separator. In an implementation, the separator composition may be cast on a support and dried, a separation film may be separated from the support, and then the separation film may be laminated on the electrode to form a separator.

The polymer resin used in the production of the separator may include a suitable material of a binder of an electrode plate. For example, as the polymer resin, a vinylidene fluoride/hexafluoropropylene copolymer, polyvinylidene fluoride (PVDF), polyacrylonitrile, polymethyl methacrylate, or a mixture thereof may be used.

Next, the aforementioned electrolyte for the lithium secondary battery may be prepared.

As shown in the FIGURE, a separator 2 may be located between a cathode 3 and an anode 4 to form a battery structure. The battery structure is laminated and then impregnated with an organic electrolyte, and the resulting product is accommodated in a pouch 5 and sealed to complete a lithium ion polymer battery. In this case, the cathode 3 and the anode 4 may be attached to each other through a protective tape 6, and each of the cathode 3 and the anode 4 may have an electrode tap 7 located to partially protrude outward.

In an implementation, the lithium secondary battery 1 may include a cathode 3, an anode 4, and a separator 2. The anode 4, the cathode 3, and the separator 2 may be wound or folded and accommodated in a battery case. Then, an electrolyte for a lithium secondary battery may be injected into the battery case, and the battery case may be sealed with a cap assembly to complete the lithium secondary battery. The battery case 5 may have a cylindrical shape, a rectangular shape, or a thin film shape. For example, the lithium secondary battery may be a large-sized thin-film battery. The lithium secondary battery may be a lithium ion battery.

In an implementation, a plurality of battery structures may be laminated to form a battery pack, and this battery pack may be used in appliances requiring high capacity and high power. For example, the battery pack may be used in notebooks, smart phones, electric vehicles, and the like.

In an implementation, a DCIR increase rate of the lithium secondary battery according to an embodiment after 200 charge-discharge cycles at 45° C. may be 100% or less.

In an implementation, the lithium secondary battery may exhibit excellent lifetime characteristics and high efficiency characteristics, and may be used in electric vehicles (EVs). For example, the lithium secondary battery may be used in hybrid vehicles such as a plug-in hybrid electric vehicle (PHEV). Further, the lithium secondary battery may be used in the field requiring a large amount of electric power storage. For example, the lithium secondary battery may be used in electric bicycles, power tools, and the like.

Hereinafter, the present disclosure will be described in more detail with reference to Examples, Comparative Example, and Reference Examples.

The following Examples, Comparative Example, and Reference Examples are provided in order to highlight characteristics of one or more embodiments, but it will be understood that the Examples, Comparative Example, and Reference Examples are not to be construed as limiting the scope of the embodiments, nor are the Comparative Examples or Reference Examples to be construed as being outside the scope of the embodiments. Further, it will be understood that the embodiments are not limited to the particular details described in the Examples, Comparative Example, and Reference Examples.

### Manufacture of Lithium Secondary Battery

### Example 1

(Preparation of Cathode)

97.4 wt % of LiNi_{0.8}Co_{0.15}Al_{0.05} as a cathode active material, 1.1 wt % of carbon nanotubes and carbon black as a conductive material, and 1.5 wt % of PVDF as a binder were mixed to obtain a mixture, and the mixture was introduced into a N-methyl-2-pyrrolidone solvent and stirred using a mechanical stirrer to prepare a cathode active material composition. The cathode active material composition was applied onto an aluminum foil current collector having a thickness of 12 μm using a coater such that the thickness of solid content per unit area is about 61 μm, dried at 100° C. for 0.5 hours using a hot drier, further dried in vacuum at 120° C. for 4 hours, and then roll-pressed to prepare a cathode provided with a cathode active material layer on the current collector.

(Preparation of Anode)

97 wt % of an anode active material including a graphite-Si composite obtained by mixing artificial graphite and natural graphite, 1 wt % of CMC, 2 wt % of solid content of SBR were mixed to obtain a mixture, and the mixture was introduced into water as a solvent and stirred using a mechanical stirrer to prepare an anode active material composition. The anode active material composition was applied to a thickness of 50 μm onto a copper foil current collector having a thickness of 8 μm using a coater, dried using hot air, and then roll-pressed to prepare an anode provided with an anode active material layer on the current collector.

(Preparation of Electrolyte)

Compound 1 was added to a 1.15 M LiPF₆ solution in which ethylene carbonate (EC), propylene carbonate (PC), ethyl propionate (EP), and propyl propionate (PP), as solvents, were mixed at a ratio of 2:1:2:5, to prepare an electrolyte.

(Assembly of Veneer Pouch Cell for Material Evaluation)

A veneer pouch cell for material evaluation including one punched cathode sheet and one punched anode sheet was manufactured by using a ceramic-coated separator having a thickness of 12 μm together with the cathode, the anode, and the electrolyte, prepared in Example 1.

### Example 2

A pouch cell for material evaluation was manufactured in the same manner as in Example 1, except that an electrolyte was prepared by adding 1 wt % of Compound 2 instead of Compound 1.

### Example 3

A pouch cell for material evaluation was manufactured in the same manner as in Example 1, except that an electrolyte was prepared by adding 1 wt % of Compound 3 instead of Compound 1.

### Example 4

A pouch cell for material evaluation was manufactured in the same manner as in Example 1, except that an electrolyte was prepared by adding 1 wt % of Compound 4 instead of Compound 1.

### Example 5

A pouch cell for material evaluation was manufactured in the same manner as in Example 1, except that an electrolyte was prepared by adding 1 wt % of Compound 5 instead of Compound 1.

### Example 6

A pouch cell for material evaluation was manufactured in the same manner as in Example 1, except that an electrolyte was prepared by adding 1 wt % of Compound 6 instead of Compound 1.

### Example 7

A pouch cell for material evaluation was manufactured in the same manner as in Example 1, except that an electrolyte was prepared by adding 1 wt % of Compound 7 instead of Compound 1.

### Example 8

A pouch cell for material evaluation was manufactured in the same manner as in Example 1, except that an electrolyte was prepared by adding 1 wt % of Compound 8 instead of Compound 1.

### Example 9

A pouch cell for material evaluation was manufactured in the same manner as in Example 1, except that an electrolyte was prepared by adding 1 wt % of Compound 9 instead of Compound 1.

### Example 10

A pouch cell for material evaluation was manufactured in the same manner as in Example 1, except that an electrolyte was prepared by adding 1 wt % of Compound 10 instead of Compound 1.

### Comparative Example 1

A pouch cell for material evaluation was manufactured in the same manner as in Example 1, except that an electrolyte was prepared without adding Compound 1.

### Reference Example 1

A pouch cell for material evaluation was manufactured in the same manner as in Example 1, except that a cathode active material was prepared by using LiCoO₂ instead of the LiNi_{0.8}Co_{0.5}Al_{0.05}.

### Reference Example 2

A pouch cell for material evaluation was manufactured in the same manner as in Reference Example 1, except that an electrolyte was prepared without adding Compound 1.

### Reference Example 3

A pouch cell for material evaluation was manufactured in the same manner as in Example 1, except that LiNi_{0.8}Co_{0.2}Mn_{0.3} was used instead of LiNi_{0.8}Co_{0.15}Al_{0.05} as a cathode active material.

### Reference Example 4

A pouch cell for material evaluation was manufactured in the same manner as in Reference Example 3, except that an electrolyte was prepared without adding Compound 1.

### Evaluation Example

In the pouch cells for material evaluation manufactured in Examples 1 to 10, Comparative Example 1 and Reference Examples 1 to 4, in order to separate only resistance from the surface of the cathode, coin half cells were manufactured using only the cathode, and the resistance thereof was measured using electrochemical impedance spectroscopy (EIS). Further, the aforementioned veneer pouch cells for material evaluation were manufactured, and the initial 1C capacitance and charge transfer resistance (Rct) thereof were measured with respect to lifetime and storage characteristics. Then, charge-discharge cycles in which the pouch cells were charged with a constant current up to 4.2 V at a rate of 0.7 C at ambient temperature (25° C.) and high temperature (45° C.), and then charged with a constant voltage up to a current of 0.05 C while maintaining a voltage of 4.2 V were repeated 200 times. Then, discharge capacitance of the pouch cells was measured, and lifetimes thereof were compared. The results thereof are given in Table 1 below.

The lifetime is defined by Equation 1 below.

Lifetime [%]=[discharge capacitance after 200^{th} cycle/standard capacitance]×100 (the standard capacitance is a discharge capacitance at 2^{nd} cycle) <Equation 1>

TABLE 1

| | | | Charge | | | | |
|---|---|---|---|---|---|---|---|
| | | | transfer | | | | |
| | Half cell | Initial 1 C | resistance | Life time at 25° C. | | Life time at 45° C. | |
| | resistance | capacitance | (Rct) | (%) | | (%) | |
| | EIS(Ω) | (mAh) | (Ω) | 1 C | 0.2 C | 1 C | 0.2 C |
| Example 1 | 62 | 31.4 | 0.998 | 72.7 | 74.5 | 56.0 | 63.4 |
| Example 2 | 40 | 27.8 | 0.930 | 74.9 | 76.2 | 63.4 | 72.5 |
| Example 3 | 75 | 31.7 | 1.073 | 74.3 | 76.6 | 58.3 | 71.6 |
| Example 4 | 73 | 27.7 | 1.145 | 77.0 | 79.7 | 63.4 | 74.6 |
| Example 5 | 78 | 31.9 | 1.158 | 74.9 | 77.0 | 63.3 | 75.3 |
| Example 6 | 77 | 31.9 | 1.166 | 76.1 | 79.4 | 64.1 | 73.7 |
| Example 7 | 70 | 31.9 | 1.130 | 77.7 | 79.2 | 67.0 | 74.8 |
| Example 8 | 53 | 31.9 | 1.120 | 73.3 | 78.3 | 59.4 | 72.9 |
| Example 9 | 62 | 32.1 | 1.033 | 72.0 | 74.1 | 67.3 | 80.1 |
| Example 10 | 68 | 32.1 | 1.169 | 75.5 | 78.0 | 63.4 | 72.6 |
| Comparative | 120 | 32.5 | 1.330 | 69.5 | 78.5 | 53.0 | 68.7 |
| Example 1 | | | | | | | |
| Reference | — | 38.0 | 1.62 | 81.54 | — | 78.57 | — |
| Example 1 | | | | | | | |
| Reference | — | 38.9 | 1.51 | 81.81 | — | 78.39 | — |
| Example 2 | | | | | | | |
| Reference | — | 36.6 | 0.90 | 87.75 | — | 85.59 | — |
| Example 3 | | | | | | | |
| Reference | — | 36.8 | 0.93 | 88.02 | — | 85.68 | — |
| Example 4 | | | | | | | |

As seen in Table 1 above, Examples 1 to 10 (in which an isocyanate compound was included in the electrolyte) exhibited excellent resistance characteristics and high efficiency lifetime characteristics, as compared with Comparative Example 1 (in which an isocyanate compound was not included in the electrolyte).

Further, referring to Reference Examples 1, 2, 3, and 4, it may be seen that Reference Examples 1 and 3 (in which an isocyanate compound was included in the electrolyte) exhibited poor in capacitance characteristics, resistance characteristics, and lifetime characteristics as compared with Reference Examples 2 and 4 (in which an isocyanate compound was not included in the electrolyte). For example, it may be seen that when an LCO cathode active material or a cathode active material having a low Ni content was used, even if the isocyanate compound was added to an electrolyte, not only were effects not improved, but also resistance, capacitance, and/or lifetime characteristics were deteriorated.

It may be seen that when the isocyanate compound according to an embodiment was used together with a lithium transition metal layered cathode active material having a predetermined or particular Ni content, remarkably good effects were exhibited.

Subsequently, Rct after 14 days, initial Rct of 1 C capacitance, a ratio to 1 C capacitance, and Δv and ΔE after 7 days were measured, and the results thereof are given in Table 2 below.

TABLE 2

| | Rct after | 1 C capacitance | | |
|---|---|---|---|---|
| | 14 days/ | after 14 days/ | | |
| | initial Rct | initial 1 C | ΔV | ΔE |
| | (%) | capacitance (%) | (ml) | (V) |
| Example 1 | 16.86 | 78.99 | 0.075 | 0.229 |
| Example 2 | 61.77 | 87.10 | 0.160 | 0.178 |
| Example 3 | 40.98 | 84.60 | 0.220 | 0.188 |
| Example 4 | 39.56 | 85.10 | 0.190 | 0.184 |
| Example 5 | 48.49 | 85.80 | 0.240 | 0.181 |
| Example 6 | 49.89 | 85.80 | 0.220 | 0.182 |
| Example 7 | 63.97 | 83.70 | 0.210 | 0.182 |
| Example 8 | 67.46 | 85.70 | 0.400 | 0.181 |
| Example 9 | 53.87 | 86.70 | 0.280 | 0.181 |
| Example 10 | 53.51 | 84.90 | 0.190 | 0.185 |
| Comparative Example 1 | 99.72 | 85.40 | 0.150 | 0.180 |
| Reference Example 1 | 107.6 | 92.4 | N/A | 0.097 |
| Reference Example 2 | 103.4 | 91.4 | N/A | 0.097 |
| Reference Example 3 | 98 | 93 | N/A | N/A |
| Reference Example 4 | 95 | 91 | N/A | N/A |

As may be seen in Table 2, the half cell of Examples 1-10 exhibited excellent resistance characteristics, as compared with the half cells of Comparative Example 1 and Reference Examples 1 to 4.

By way of summation and review, in the case of a high-Ni-content cathode active material, lifetime characteristics may be poor due to the weak surface structure of a cathode, a large amount of gas may be generated due to the side reaction with an electrolyte according to the increase of reactivity, and the irreversibility of a capacity source (Li ions, Mg ions, or the like) may increase.

A lithium secondary battery may include a high-Ni-content cathode active material, which exhibits high capacity, good lifetime characteristics, and good gas reduction characteristics.

One or more embodiments may provide a lithium secondary battery including a specific electrolyte together with a high-Ni-content cathode active material.

According to an embodiment, a lithium secondary battery may include a specific electrolyte together with a high-Ni-content cathode active material, the lithium secondary battery may include a film including a urethane (—NH—CO—) group formed on the surface of an electrode by an NCO addition reaction, the resistance of the lithium secondary battery before and after formation may decrease, and the resistance increase rate of the lithium secondary battery due to high-temperature storage may decrease. Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A lithium secondary battery, comprising:
a cathode;
an anode; and
an electrolyte between the cathode and the anode,
wherein:
the electrolyte includes a lithium salt; a non-aqueous solvent; and an isocyanate compound, and
the cathode includes a cathode active material represented by Formula 1, below,
LiₓNi_{y}M_{1-y}O_{2-z}A_{z} <Formula 1>
wherein, in Formula 1,
x, y, and z satisfy the following relations: 0.9≤x≤1.2, 0.6<y≤0.98, and 0≤z<0.2,
M is Al, Mg, Mn, Co, Fe, Cr, V, Ti, Cu, B, Ca, Zn, Zr, Nb, Mo, Sr, Sb, W, or Bi, and
A is an element having an oxidation number of −1 or −2.

2. The lithium secondary battery as claimed in claim 1, wherein the isocyanate compound includes at least one isocyanate group.

3. The lithium secondary battery as claimed in claim 1, wherein the isocyanate compound is represented by Formula 2 below:
X₁—N═C═O <Formula 2>
wherein, in Formula 2,
X₁ is —Si(R)₃, —S(═O)₂R, —Si(R)₂—O—Si(R)₃, —C(═O)OR, or —P(R)₂,
each R is independently hydrogen, —F, —Cl, —Br, —I, an isocyanate group, a cyano group, a nitro group, an amidino group, a hydrazino group, hydrazono group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
at least one substituent of the substituted C₁-C₂₀ alkyl group, the substituted C₂-C₂₀ alkenyl group, the substituted C₂-C₂₀ alkynyl group, and the substituted C₁-C₂₀ alkoxy group is deuterium, —F, —Cl, —Br, —I, a hydroxyl group, a cyano group, a nitro group, an amidino group, a hydrazino group, a hydrazono group, a C₁-C₁₀ alkyl group, a C₂-C₁₀ alkenyl group, a C₂-C₁₀ alkynyl group, or a C₁-C₂₀ alkoxy group, and
Q₁ to Q₃ are each independently hydrogen, deuterium, —F, —Cl, —Br, —I, a hydroxyl group, a cyano group, a nitro group, an amidino group, a hydrazino group, hydrazono group, a C₁-C₂₀ alkyl group, a C₂-C₂₀ alkenyl group, a C₂-C₂₀ alkynyl group, or a C₁-C₂₀ alkoxy group.

4. The lithium secondary battery as claimed in claim 3, wherein:
i) the isocyanate compound includes one isocyanate group, and X₁ is —S(═O)₂R, —Si(R)₂—O—Si(R)₃ or —C(═O)OR, and R is —F, or
ii) the isocyanate compound includes two or three isocyanate groups, and X₁ is —Si(R)₃, —S(═O)₂R, —Si(R)₂—O—Si(R)₃, or —C(═O)OR.

5. The lithium secondary battery as claimed in claim 1, wherein the isocyanate compound is a compound represented by one of Formulae 2-1 to 2-5: 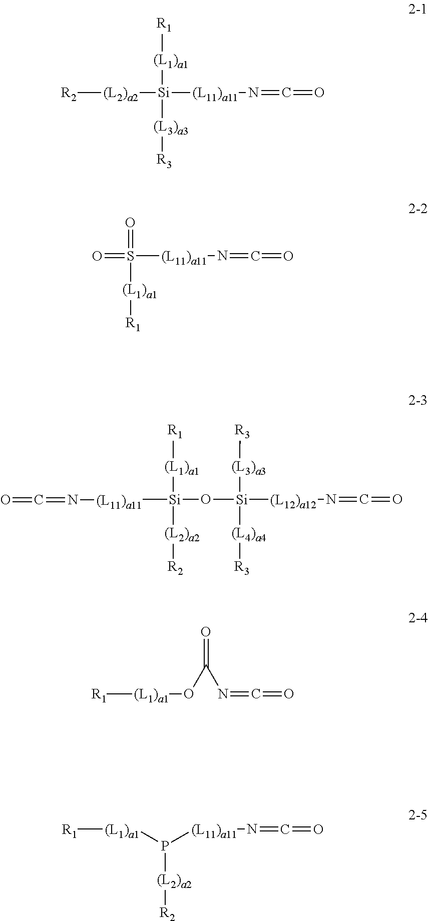
wherein, in Formulae 2-1 to 2-5,
L₁ to L₄ and L₁₁ are each independently a single bond, *—O—*, or a substituted or unsubstituted C₁-C₃₀alkylene group,
a1 to a4 and a11 are each independently an integer of 1 to 5,
R₁ to R₄ are each independently —F, —Cl, —Br, —I, an isocyanate group, a cyano group, a nitro group, an amidino group, a hydrazino group, a hydrazono group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
at least one substituent of the substituted C₁-C₃₀ alkylene group, the substituted C₁-C₂₀ alkyl group, the substituted C₂-C₂₀ alkenyl group, the substituted C₂-C₂₀ alkynyl group, and the substituted C₁-C₂₀ alkoxy group is deuterium, —F, —Cl, —Br, —I, a hydroxyl group, a cyano group, a nitro group, an amidino group, a hydrazino group, a hydrazono group, a C₁-C₁₀ alkyl group, a C₂-C₁₀ alkenyl group, a C₂-C₁₀ alkynyl group, or a C₁-C₂₀ alkoxy group,
Q₁ to Q₃ are each independently hydrogen, deuterium, —F, —Cl, —Br, —I, a hydroxyl group, a cyano group, a nitro group, an amidino group, a hydrazino group, hydrazono group, a C₁-C₂₀ alkyl group, a C₂-C₂₀ alkenyl group, a C₂-C₂₀ alkynyl group, or a C₁-C₂₀ alkoxy group, and
each of * and *′ indicates a binding site to an adjacent atom.

6. The lithium secondary battery as claimed in claim 5, wherein R₁ to R₄ are each independently a methyl group, an ethyl group, a propyl group, an iso-propyl group, a butyl group, an iso-butyl group, a sec-butyl group, a tert-butyl group, —F, —Cl, —Br, —I, a methoxy group, an ethoxy group, an ethenyl group, an isocyanate group, or a —CF₃ group.

7. The lithium secondary battery as claimed in claim 1, wherein the isocyanate compound includes one isocyanate group or two isocyanate groups.

8. The lithium secondary battery as claimed in claim 1, wherein the isocyanate compound is one of compounds 1 to 10 below:

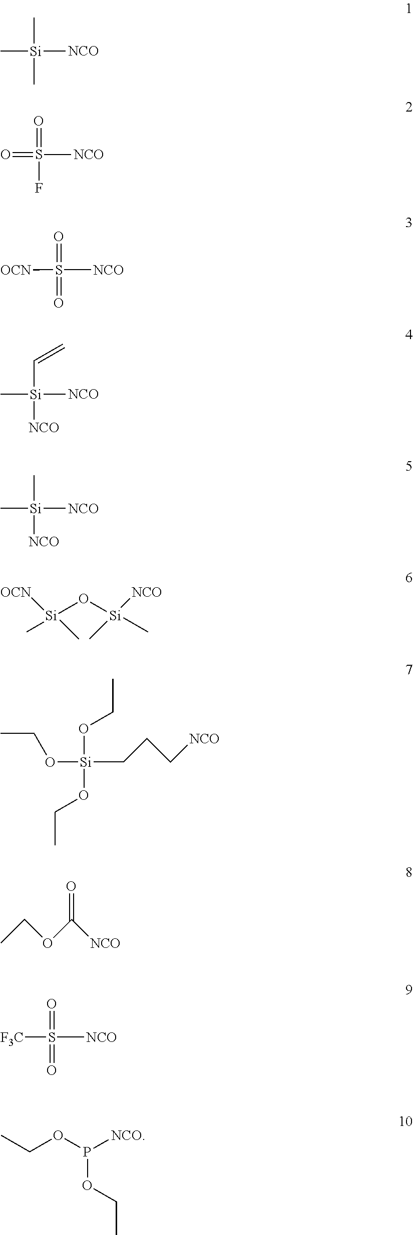

9. The lithium secondary battery as claimed in claim 1, wherein the isocyanate compound is included in the electrolyte in an amount of about 0.005 wt % to about 10 wt %, based on a total weight of the electrolyte.

10. The lithium secondary battery as claimed in claim 1, wherein the isocyanate compound is included in the electrolyte in an amount of about 0.01 wt % to about 5 wt %, based on a total weight of the electrolyte.

11. The lithium secondary battery as claimed in claim 1, wherein the non-aqueous solvent includes ethylmethyl carbonate, methylpropyl carbonate, ethylpropyl carbonate, dimethyl carbonate, diethyl carbonate, dipropyl carbonate, propylene carbonate, ethylenecarbonate, fluoroethylene carbonate, butylene carbonate, ethyl propionate, propyl propionate, ethyl butyrate, acetonitrile, dimethyl sulfoxide, dimethyl formamide, dimethylacetamide, gamma-valerolactone, gamma-butyrolactone, or tetrahydrofuran.

12. The lithium secondary battery as claimed in claim 1, wherein the lithium salt includes LiPF₆, LiBF₄, LiSbF₆, LiAsF₆, LiClO₄, LiBr, CH₃SO₃Li, (CF₃SO₂)₂NLi, lithium chloroborane, lower aliphatic carboxylic acid lithium, lithium 4-phenylborate, lithium imide, LiCF₃SO₃, LiCF₃CO₂, LiB₁₀Cl₁₀, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂), in which each of x and y is independently an integer of 1 to 20, LiCl, or LiI.

13. The lithium secondary battery as claimed in claim 1, wherein a concentration of the lithium salt in the electrolyte is about 0.01 M to about 5.0 M.

14. The lithium secondary battery as claimed in claim 1, wherein the cathode active material is represented by Formula 3 or Formula 4 below:
Li_{x′}Ni_{y′}Co_{1-y′-y″}—Al_{y″}O₂ <Formula 3>
Li_{x′}Ni_{y′}Co_{1-y′-y″}Mn_{y″}O₂ <Formula 4>
wherein, in Formulae 3 and 4, x′, y′, and y″ satisfy the following relations: 0.9≤x′≤1.2, 0.6<y′≤0.98, 0<y″<0.1, and 0<1−y′−y″<0.2.

15. The lithium secondary battery as claimed in claim 1, wherein the anode includes lithium metal, a metal alloyable with lithium, a transition metal oxide, a non-transition metal oxide, or a carbon material.

16. The lithium secondary battery as claimed in claim 1, further comprising a urethane group-containing film on a surface of the cathode or the anode.

17. The lithium secondary battery as claimed in claim 16, wherein the urethane group-containing film is on the surface of the anode.

18. The lithium secondary battery as claimed in claim 16, wherein:
the cathode or the anode includes a —OH group or H₂O on a surface thereof, and
a urethane group of the urethane group-containing film is formed by a reaction of the —OH group or the H₂O with an isocyanate group of the isocyanate compound.

19. The lithium secondary battery as claimed in claim 1, wherein a DCIR increase rate after 200 charge-discharge cycles at 45° C. is 100% or less.
